(19) United States
(12) Patent Application Publication
(10) Pub. No.: US 2023/0397114 A1
(43) Pub. Date: Dec. 7, 2023

(54) WIRELESS COMMUNICATION SYSTEM, WIRELESS COMMUNICATION METHOD AND TERMINAL DEVICE

(71) Applicant: Nippon Telegraph and Telephone Corporation, Tokyo (JP)

(72) Inventors: Kento YOSHIZAWA, Musashino-shi, Tokyo (JP); Yosuke FUJINO, Musashino-shi, Tokyo (JP); Yohei KATAYAMA, Musashino-shi, Tokyo (JP); Ryo MIYATAKE, Musashino-shi, Tokyo (JP)

(21) Appl. No.: 18/032,147

(22) PCT Filed: Oct. 16, 2020
(86) PCT No.: PCT/JP2020/039105

§ 371 Date: Apr. 14, 2023

(51) Int. Cl. H04W 52/02

(52) U.S. Cl. CPC H04W 52/0235; H04W 52/0274

(57) ABSTRACT

One aspect of the present invention is a wireless communication system including: one or more terminal devices of which operation mode transitions between a first mode in which a wireless signal can be intermittently detected and a second mode in which data can be transmitted or received; and a gateway device that transmits, at a predetermined transmission interval, an instruction frame instructing the one or more terminal devices to shift to the second mode, wherein the one or more terminal devices each include an instruction frame detection unit that performs detection processing on the instruction frame, and a control unit that shifts an operation mode of the device from the first mode to the second mode on the basis of the number of times the instruction frame is detected.

### TECHNICAL FIELD

The present invention relates to a technology for a wireless communication system, a wireless communication method, and a terminal device.

### BACKGROUND ART

A sensor terminal or the like of IoT (Internet of Things) is often used on battery power and is sometimes required to have a longer life of more than ten years. Since communication requests and frequency, in particular, are relatively low in IoT communications compared to other wireless communications, a method of having terminal devices communicate intermittently (intermittent communication) has been proposed. Specifically, the intermittent communication is realized by shifting an operation mode of a terminal device between a communication mode capable of communication and a sleep mode capable of operating with low power. Since the intermittent communication can be controlled with a simple configuration when a communication request is periodically generated, designing thereof can be relatively easily performed. On the other hand, when a communication request is generated at random timing, since both the transmitting side and the receiving side has to be shifted to the communication mode at random timing, the control becomes complicated and the designing also becomes difficult.

For example, as a method for shifting the operation mode of the terminal device from the sleep mode to the communication mode, there exists a method of transmitting a frame for instructing the terminal device to shift from the sleep mode to the communication mode (referred to as “activation instruction frame” hereinafter). Hereinafter, an instruction for shifting from the sleep mode to the communication mode is referred to as an activation instruction, and a transition of the terminal device from the sleep mode to the communication mode is referred to as “activation.” Further, the processing for shifting the terminal device from the sleep mode to the communication mode is referred to as “activation processing,” and the terminal device to which the activation instruction is directed is referred to as “target terminal.” In this method, a gateway device continues to transmit an activation instruction frame at a predetermined transmission interval until the activation of the target terminal can be confirmed. On the other hand, the target terminal in the sleep mode periodically attempts to detect the activation instruction frame, shifts to the communication mode when the detection of the activation instruction frame is successful, and continues to operate in the sleep mode when failing the detection of the activation instruction frame.

In order to achieve further improvement in power saving, a method has been proposed in which a terminal device is caused to detect an activation instruction frame by detecting a preamble of the activation instruction frame. In this method, the operation mode of the terminal device transitions between a detection mode in which an activation instruction frame can be detected, a communication mode in which communication with the gateway device can be performed, and a sleep mode in which communication is not performed. The detection mode is an operation mode in which radio signals can be detected but frames are not transmitted or received, and is an operation mode in which an operation at lower power than that in the communication mode can be performed.

FIG. 6 is a timing chart for explaining a flow of operation in which a control device (referred to as “gateway device” hereinafter) in the prior art shifts the operation mode of a terminal device from the sleep mode to the communication mode. In this example, first the gateway device transmits an activation instruction frame at time t₁₀. However, since the detection timing for the terminal device does not arrive during a period P₀ in which a preamble of the activation instruction frame is detectable, the terminal device remains in the sleep mode. Since the activation of the terminal device cannot be confirmed, the gateway device determines to transmit the activation instruction frame again at time t₁₂ which is the next transmission timing. Here, time t₁₂ is a time reached when a predetermined transmission interval T_{BCN} has elapsed from time t₁₀. The activation instruction frame is generated by adding, to a payload storing transmission data, a preamble indicating that the preamble is the activation instruction frame.

Then, the detection timing for the terminal device arrives at time t₁₁. The terminal device shifts to the detection mode in response to the arrival of the detection timing, and executes detection processing for detecting the activation instruction frame. However, since the gateway device does not transmit the activation instruction frame at this timing, the terminal device shifts to the sleep mode again without detecting the activation instruction frame.

Next, at time t₁₂, the gateway device transmits the activation instruction frame again. In addition, during a period P₁ in which a preamble of the activation instruction frame can be detected, the detection timing for the terminal device arrives again (time t₁₃). The terminal device shifts to the detection mode again in response to the arrival of the detection timing, and executes the detection processing for detecting the activation instruction frame. At this timing, since the gateway device transmits the preamble of the activation instruction frame, the terminal device detects the activation instruction frame and shifts from the detection mode to the communication mode in response to the detection. Once the terminal device shifts to the communication mode, the terminal device receives the detected activation instruction frame and transmits a data frame to the gateway device, and then shifts to the sleep mode again. On the other hand, when it is confirmed that the terminal device has shifted to the communication mode (that is, the terminal device has been activated), the gateway device shifts to a reception mode to be described later and ends the transmission of the activation instruction frame. The gateway device receives the data frame from the terminal device after shifting to the reception mode, and shifts to the sleep mode when communication with the terminal device is terminated normally.

FIGS. 7 and 8 are flow charts showing a flow of processing for realizing such control method of the prior art. FIG. 7 shows a flow of processing by the gateway device, and FIG. 8 shows a flow of processing by the terminal device. The processing by the gateway device will be described first. At the starting point of the flowchart, the gateway device operates in a transmission mode in which data transmission is possible, and stands by until the transmission timing for transmitting an activation instruction frame arrives. The gateway device transmits an activation instruction frame when the transmission timing arrives (step S11), and shifts to a reception mode in which data reception is possible (step S12).

Subsequently, the gateway device determines whether or not a data transmission request is received from the terminal device (step S13). When it is determined that the data transmission request is not received (step S13—NO), the gateway device returns the processing to step S11 after waiting for a predetermined period of time (step S14) and transmits the activation instruction frame again. On the other hand, when it is determined that the data transmission request is received (step S13—YES), the gateway device transmits a data transmission instruction to the terminal device (step S15). The gateway device receives the data transmitted by the terminal device in response to the data transmission instruction (step S16), and a series of processing ends.

The processing by the terminal device will be described next (FIG. 8). At the starting point of the flowchart, the terminal device operates in the sleep mode and waits for the timing to detect the activation instruction frame to arrive. When the detection timing arrives, the terminal device shifts to the detection mode in which the activation instruction frame can be detected, and executes detection processing for detecting a preamble of the activation instruction frame (step S21). Then, the terminal device determines whether or not a preamble of the activation instruction frame is detected (step S22). When it is determined that a preamble of the activation instruction frame is not detected (step S22—NO), the terminal device shifts to the sleep mode again, and waits for the arrival of the next detection timing (step S23). In this case, when the next detection timing arrives, the terminal device shifts to the detection mode again and returns the processing to the step S21.

On the other hand, when it is determined that a preamble of the activation instruction frame is detected (step S22—YES), the terminal device transmits a data transmission request to the gateway device (step S24) and waits for a data transmission instruction to be received from the gateway device (step S25). The terminal device transmits data to the gateway device in response to the reception of the data transmission instruction from the gateway device (step S26).

FIGS. 9 and 10 are diagrams schematically showing state transitions between the terminal device and the gateway device in the prior art. FIG. 9 shows a state transition of the gateway device, and FIG. 10 shows a state transition of the terminal device. The state transition of the gateway device will be described first (FIG. 9). The operation mode of the gateway device transitions between three operation modes, a transmission mode, a reception mode, and a sleep mode. The transmission mode is a state in which an activation instruction frame can be transmitted. The gateway device operating in the transmission mode shifts to the reception mode when a communication request is generated from the terminal device. The reception mode is a state in which reception (or transmission/reception) of data is possible.

For example, the gateway device receives data from the terminal device in the reception mode. The gateway device operating in the reception mode shifts to the sleep mode when data reception from the terminal device is terminated normally. The sleep mode is an operation mode in which the gate device is operated with low power and is an operation mode in which data is not transmitted or received. The gateway device operating in the sleep mode shifts to the transmission mode upon an occurrence of a predetermined event. For example, the gateway device operating (or waiting) in the sleep mode shifts to the transmission mode when a communication request to the terminal device is notified from a higher layer of a communication function (such as an application layer). If power saving is not required for the gateway device, the gateway device may shift to an operation mode (standby mode) in which the next transmission/reception is simply waited instead of the sleep mode.

The state transition of the terminal device will be described next (FIG. 10). The operation mode of the terminal device transitions among three operation modes, a detection mode, a communication mode, and a sleep mode. As described above, the detection mode is an operation mode in which an activation instruction frame can be detected. Specifically, the terminal device detects an activation instruction frame by detecting a preamble of the activation instruction frame. Upon detection of the activation instruction frame, the terminal device operating in the detection mode shifts to the communication mode. The terminal device operating in the detection mode shifts to the sleep mode when the activation instruction frame is not detected.

The communication mode is a state in which transmission (or transmission/reception) of data is possible. For example, the terminal device transmits a data transmission request to the gateway device in the communication mode, and transmits data to the gateway device in response to reception of a data transmission instruction from the gateway device. The terminal device operating in the communication mode shifts to the sleep mode when communication with the gateway device is terminated normally. The sleep mode is an operation mode in which the terminal device is operated with low power and is an operation mode in which data is not transmitted or received. The terminal device operating in the sleep mode shifts to the detection mode upon an occurrence of a predetermined event. For example, in a case where an interruption of notifying the detection timing for detecting the activation instruction frame occurs in the terminal device operating in the sleep mode, the terminal device shifts to the detection mode.

According to such a control method, a preamble length of an activation instruction frame transmitted by the gateway device and an interval at which the terminal device detects a preamble of the activation instruction frame are appropriately set, so that even when a communication request is generated at an arbitrary timing, both the transmission side (the terminal device in the illustrated example) and the reception side (the gateway device in the illustrated example) can transition to an operation mode that enables communicable therebetween.

However, in a radio wave method, there constraints in terms of the time when one terminal device can continuously transmit and the ratio (also called Duty ratio) of the total transmission time per unit time. For this reason, in order to realize a method for controlling the operation mode of a communication device by transmitting a frame having a very long preamble a plurality of times, constraints by the radio wave method need to be cleared.

Therefore, in setting a preamble length of an activation instruction frame to be transmitted by the gateway device and a transmission interval of the frame, and an interval at which the terminal device detects the activation instruction frame, a method of using the properties of prime numbers has been devised (see PTL 1, for example). In an IoT communication system in which a transmitter for transmitting an activation instruction frame (such as the gateway device described above) and a receiver for receiving the activation instruction frame (such as the terminal device described above) are often one-to-many, when trying to activate the receiver, which operates intermittently, by transmitting an activation instruction frame from the transmitter, the higher the number of receivers, the more difficult it is to clear the constraints on the Duty ratio of the transmitter. In order to solve such a problem, the use of the technique of PTL 1 enables setting of the intervals of the intermittent operations of the gateway device and the terminal device to desired intervals while keeping the constraints of the radio wave method, even when there are many receivers to be instructed to start.

### CITATION LIST

### Patent Literature

[PTL 1] Japanese Patent Application No. 6542959

### SUMMARY OF INVENTION

### Technical Problem

However, although the prior art enables setting of desired intermittent operation intervals even when there are many receivers, it is impossible to prevent receivers from erroneously detecting an activation instruction frame and activating. For example, a receiver may erroneously detect, as an activation instruction frame, a signal similar to an activation instruction frame transmitted by a transmitter (e.g., a signal similar in characteristics such as a frequency and a modulation system). As described above, in order to increase the life of a communication device, erroneous activation of a receiver is nor favorable as it causes wasteful power consumption.

In view of the foregoing circumstances, an object of the present invention is to provide a technique capable of preventing an intermittently operating terminal device from erroneously detecting an activation instruction frame.

### Solution to Problem

One aspect of the present invention is a wireless communication system including: one or more terminal devices of which operation mode transitions between a first mode in which a wireless signal can be intermittently detected and a second mode in which data can be transmitted or received; and a gateway device that transmits, at a predetermined transmission interval, an instruction frame instructing the one or more terminal devices to shift to the second mode, wherein the one or more terminal devices each include an instruction frame detection unit that performs detection processing on the instruction frame, and a control unit that shifts an operation mode of the device from the first mode to the second mode on the basis of the number of times the instruction frame is detected.

One aspect of the present invention is a wireless communication method which, in a wireless communication system including: one or more terminal devices of which operation mode transitions between a first mode in which a wireless signal can be intermittently detected and a second mode in which data can be transmitted or received; and a gateway device that transmits, at a predetermined transmission interval, an instruction frame instructing the one or more terminal devices to shift to the second mode, causes each of the one or more terminal devices to execute: an instruction frame detection step of performing detection processing on the instruction frame; and a control step of shifting an operation mode of the device from the first mode to the second mode on the basis of the number of times the instruction frame is detected.

One aspect of the present invention is a terminal device which is each of one or more terminal devices of a wireless communication system including: the one or more terminal devices of which operation mode transitions between a first mode in which a wireless signal can be intermittently detected and a second mode in which data can be transmitted or received; and a gateway device that transmits, at a predetermined transmission interval, an instruction frame instructing the one or more terminal devices to shift to the second mode, wherein the one or more terminal devices each include an instruction frame detection unit that performs detection processing on the instruction frame, and a control unit that shifts an operation mode of the device from the first mode to the second mode on the basis of the number of times the instruction frame is detected.

### Advantageous Effects of Invention

According to the present invention, power consumption of a terminal device that performs wireless communication by intermittent operation can be reduced.

### BRIEF DESCRIPTION OF DRAWINGS

FIG. 1 is a diagram showing an example of a system configuration of a wireless communication system according to an embodiment.

FIG. 2 is a flowchart showing an example of processing in which a terminal device of an embodiment controls a state transition of its own device.

FIG. 3 is a diagram showing an example of an operation by the wireless communication system according to an embodiment.

FIG. 4 is a diagram showing a specific example of a state transition of the terminal device in an embodiment.

FIG. 5 is a diagram showing an example of an operation by a wireless communication system of a modification.

FIG. 6 is a timing chart for explaining a flow of operations in the prior art in which a gateway device shifts an operation mode of a terminal device from a sleep mode to a communication mode.

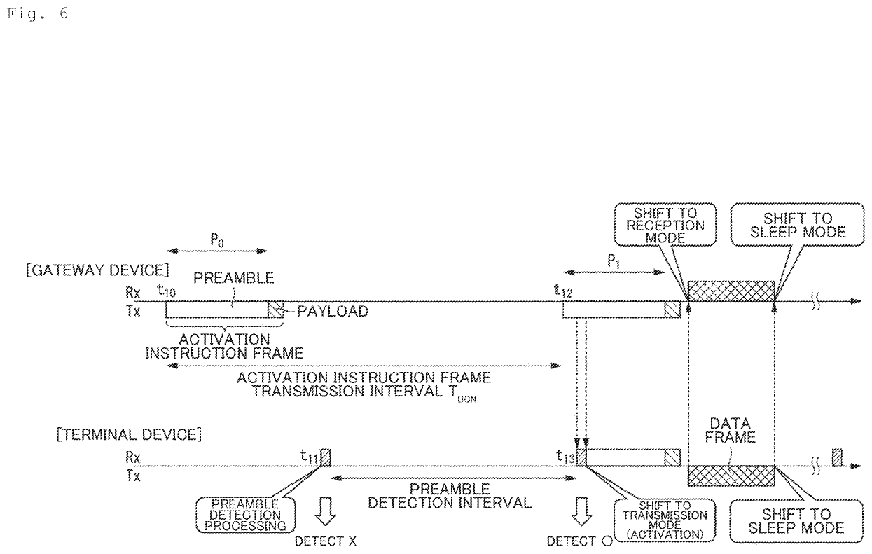

FIG. 7 is a flowchart showing a flow of processing of the gateway device of the prior art.

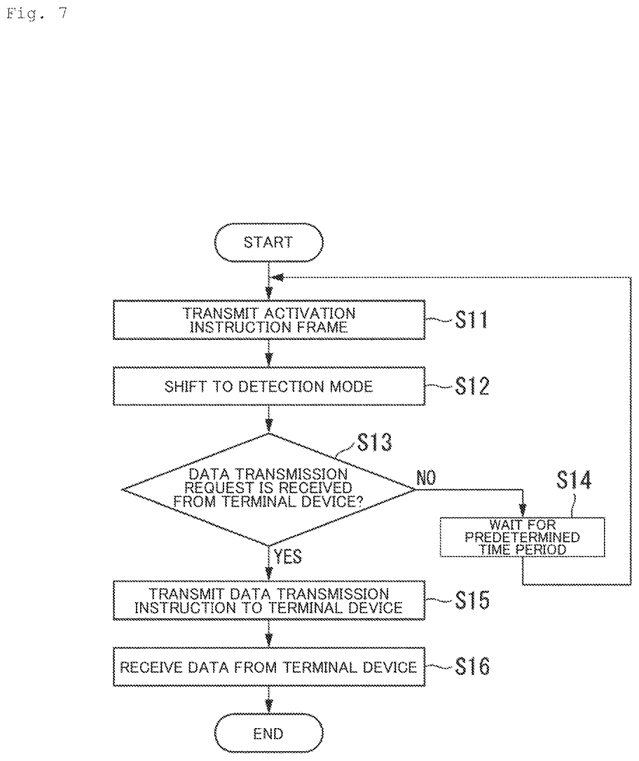

FIG. 8 is a flowchart showing a flow of processing of the terminal device of the prior art.

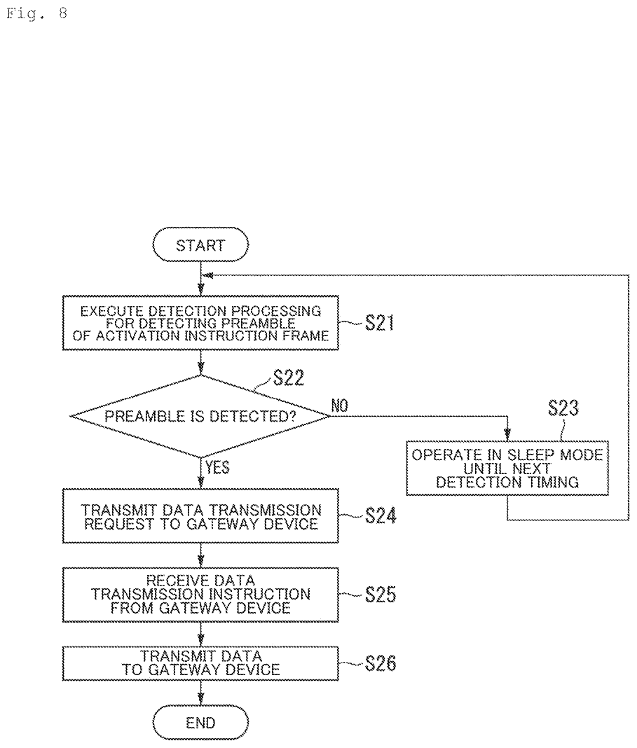

FIG. 9 is a diagram showing a state transition related to a communication function of the gateway device of the prior art.

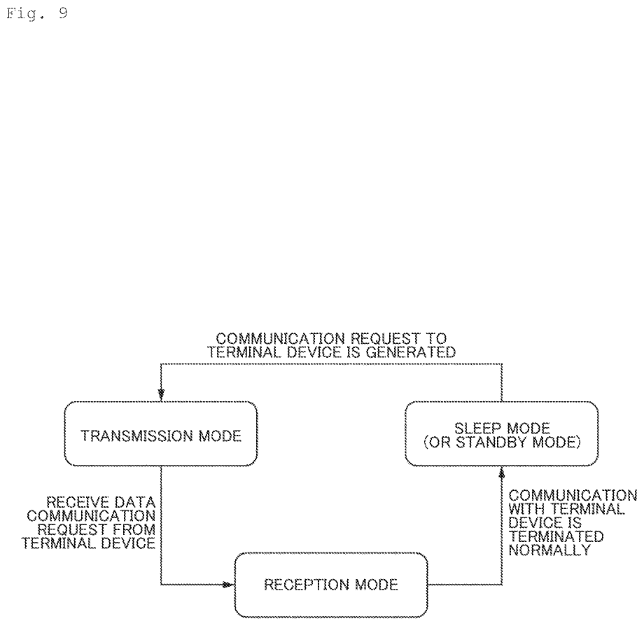

FIG. 10 is a diagram showing a state transition related to a communication function of the terminal device of the prior art.

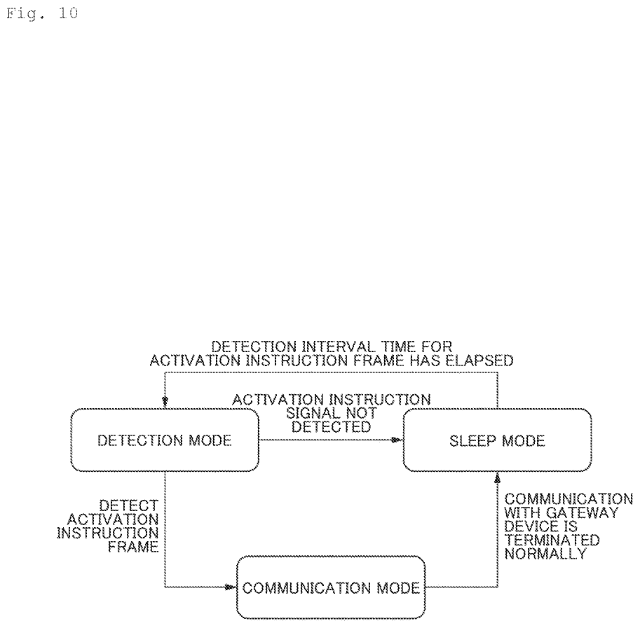

### DESCRIPTION OF EMBODIMENTS

Embodiments of the present invention will be described in detail with reference to the drawings.

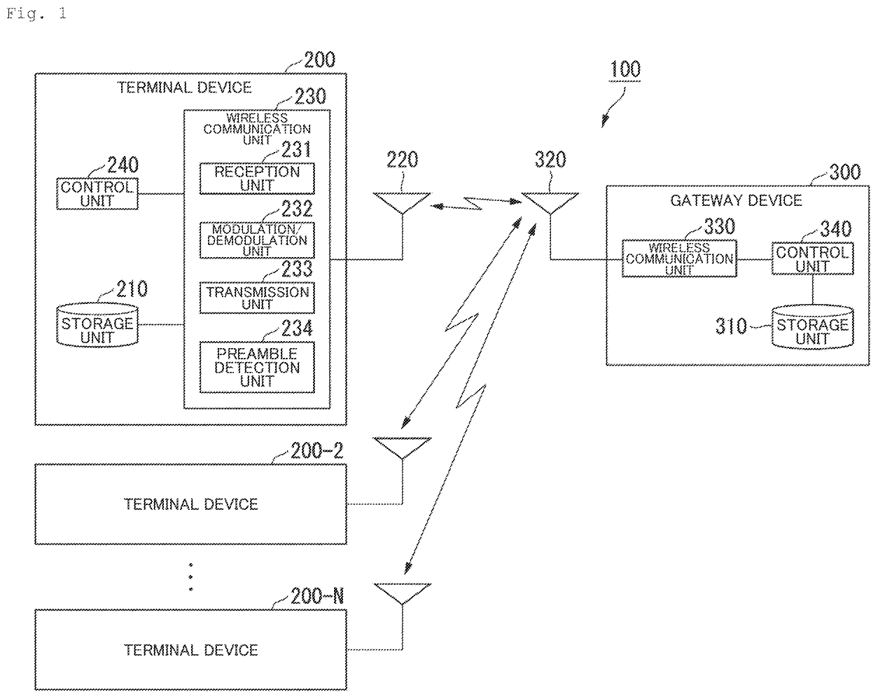

FIG. 1 is a diagram showing an example of a system configuration of a wireless communication system 100 according to an embodiment.

The wireless communication system 100 includes terminal devices 200-1 to 200-N (N is an integer of 1 or more) and a gateway device 300. A terminal devices 200 and the gateway device 300 each include an antenna for transmitting and receiving a wireless signal, and are connected to each other via the respective antennas so as to be able to communicate wirelessly. In the following description, unless otherwise distinguished, the terminal devices 200-1 to 200-N are described as the terminal device 200.

The terminal device 200 includes a CPU (Central Processing Unit), a memory, an auxiliary storage device and the like connected by a bus, and executes a program. The terminal device 200 functions as a device equipped with a storage unit 210, a radio antenna 220, a wireless communication unit 230, and control unit 240, by the execution of the program. All or part of the respective functions of the terminal device 200 may be implemented using hardware such as an ASIC (Application Specific Integrated Circuit), a PLD (Programmable Logic Device), or a FPGA (Field Programmable Gate Array. The program may be recorded in a computer-readable recording medium. The computer-readable recording medium is, for example, a portable medium such as a flexible disk, a magneto-optical disk, a ROM, or a CD-ROM, or a storage device such as a hard disk built in a computer system. The program may be transmitted via an electrical communication line.

The storage unit 210 is configured using a storage device such as a magnetic storage device or a semiconductor storage device. The storage unit 210 may be a RAM (Random Access Memory) or may be a rewritable ROM (Read Only Memory) such as a flash memory. The storage unit 210 stores various types of data necessary for the operation of the terminal device 200.

The radio antenna 220 is a device that converts an input electric signal into a radio wave, and outputs the radio wave, receives the radio wave, and converts the radio wave into an electric signal. Specifically, the radio antenna 220 converts an electric signal for transmission that is output from the wireless communication unit 230 into a radio wave, and outputs the radio wave. The radio antenna 220 also converts the received radio wave into an electric signal, and outputs the electric signal obtained by the conversion to the wireless communication unit 230 as a reception signal.

The wireless communication unit 230 has a function of transmitting and receiving target data to and from the gateway device 300 via the radio antenna 220. Specifically, the wireless communication unit 230 includes a transmission unit 231, a modulation/demodulation unit 232, a reception unit 233, and a preamble detection unit 234.

The transmission unit 231 has a function of transmitting transmission target data (referred to as “target data,” hereinafter) to the gateway device 300. Specifically, the transmission unit 231 acquires the target data and generates a frame for transmitting the acquired target data. The transmission unit 231 outputs the generated frame to the modulation/demodulation unit 232.

The modulation/demodulation unit 232 modulates the frame output from the transmission unit 231, to generate a transmission signal, up-converts the generated transmission signal into a frequency band of wireless transmission, and outputs the frequency band to the radio antenna 220. The modulation/demodulation unit 232 restores the frame by down-converting and demodulating the reception signal input from the radio antenna 220, and outputs the restored frame to the reception unit 233.

The reception unit 233 has a function of receiving the target data transmitted by the gateway device 300. Specifically, the reception unit 233 acquires the frame restored by demodulation of the wireless signal from the modulation/demodulation unit 232, and acquires the target data from the acquired frame. The target data to be transmitted and received by the terminal device 200 is not limited to specific data but may be any data.

The preamble detection unit 234 has a function of detecting an activation instruction frame from the wireless signal received via the radio antenna 220 (referred to as “reception signal,” hereinafter). Specifically, the preamble detection unit 234 detects an activation instruction frame by detecting a preamble of the activation instruction frame. The activation instruction frame is a frame for instructing the terminal device 200 to shift to a transmission mode.

The preamble detection unit 234 executes detection processing for detecting a preamble of an activation instruction frame at an interval of a predetermined time T_{det} (referred to as “detection interval”). For example, the preamble detection unit 234 detects a preamble by comparing the reception signal with a preset signal pattern. The signal pattern to be compared with the reception signal may be stored in the storage unit 210, for example. The preamble detection unit 234 notifies the control unit 240 of the result of the detection of the preamble. For example, the preamble detection function may be implemented by a CAD (Channel Activity Detection) function in a conventional LoRa modulation method (an example of a communication method using a chirp spread modulation method).

The control unit 240 has a function of controlling an operation mode of the terminal device 200. Specifically, the operation mode of the terminal device 200 transitions between a sleep mode, a detection mode, an intermittent detection mode, and a transmission mode. The sleep mode is an operation mode in which the terminal device 200 does not transmit or receive a wireless signal. The detection mode and the intermittent detection mode are operation modes in which a preamble of an activation instruction frame transmitted by the gateway device 300 can be detected. The detection mode and the intermittent detection mode have different preamble detection intervals. In the detection mode and the intermittent detection mode, the terminal device 200 only detects a preamble of an activation instruction frame, and does not perform frame reception processing (including demodulation and data acquisition). The transmission mode is an operation mode in which data can be transmitted. Details of a method in which the control unit 240 controls transition of operation modes are described hereinafter.

Next, a configuration of the gateway device 300 will be described. The gateway device 300 includes a CPU, a memory, an auxiliary storage device, and the like, which are connected by a bus, and executes a program. The gateway device 300 functions as a device including a storage unit 310, a radio antenna 320, a wireless communication unit 330, and a control unit 340 by the execution of the program. Note that all or part of the functions of the gateway device 300 may be implemented using hardware such as an ASIC, a PLD, or an FPGA. A program may be recorded in a computer-readable recording medium. The computer-readable recording medium is, for example, a portable medium such as a flexible disk, a magneto-optical disk, a ROM, or a CD-ROM, or a storage device such as a hard disk built in a computer system. The program may be transmitted via an electrical communication line.

The storage unit 310 is configured using a storage device such as a magnetic storage device or a semiconductor storage device. The storage unit 310 may be a RAM or a rewritable ROM such as a flash memory. The storage unit 310 stores various types of data necessary for the operation of the gateway device 300.

The radio antenna 320 is a device that converts an input electric signal into a radio wave, outputs the radio wave, receives the radio wave, and converts the radio wave into an electric signal. Specifically, the radio antenna 320 converts an electric signal for transmission that is output from the wireless communication unit 330 into a radio wave, and outputs the radio wave. The radio antenna 320 also converts the received radio wave into an electric signal, and outputs the electric signal obtained by the conversion to the wireless communication unit 330 as a reception signal.

The wireless communication unit 330 has a function of transmitting and receiving target data to and from the terminal device 200 via the radio antenna 320. Specifically, the wireless communication unit 330 modulates target data output from the control unit 340, to generate a transmission signal, up-converts the generated transmission signal into a frequency band of wireless transmission, and outputs the frequency band to the radio antenna 320. The wireless communication unit 330 restores a frame by down-converting and demodulating the reception signal input from the radio antenna 320, and outputs the restored frame to the control unit 340.

The control unit 340 has a function of controlling an operation mode of the gateway device 300. Specifically, the operation mode of the gateway device 300 transits between a sleep mode, a reception mode, and a transmission mode. The sleep mode is an operation mode in which the gateway device 300 does not transmit or receive a wireless signal. The transmission mode is a state in which an activation instruction frame can be transmitted. The reception mode is a state in which data transmitted by the terminal device 200 can be received.

In a case where a communication request to the terminal device 200 occurs, the control unit 340 causes the own device to shift from the sleep mode to the transmission mode. In the transmission mode, the control unit 340 transmits an activation instruction frame to the terminal device 200 at an interval of a predetermined time T_{BCN} (referred to as “transmission interval” hereinafter). When a data transmission request is received from the terminal device 200 which has received the activation instruction frame, the control unit 340 causes the own device to shift to the reception mode, and causes the own device to shift to the sleep mode again after communication with the terminal device 200 is terminated normally. The transmission interval T_{BCN} is a fixed value determined based on the system design.

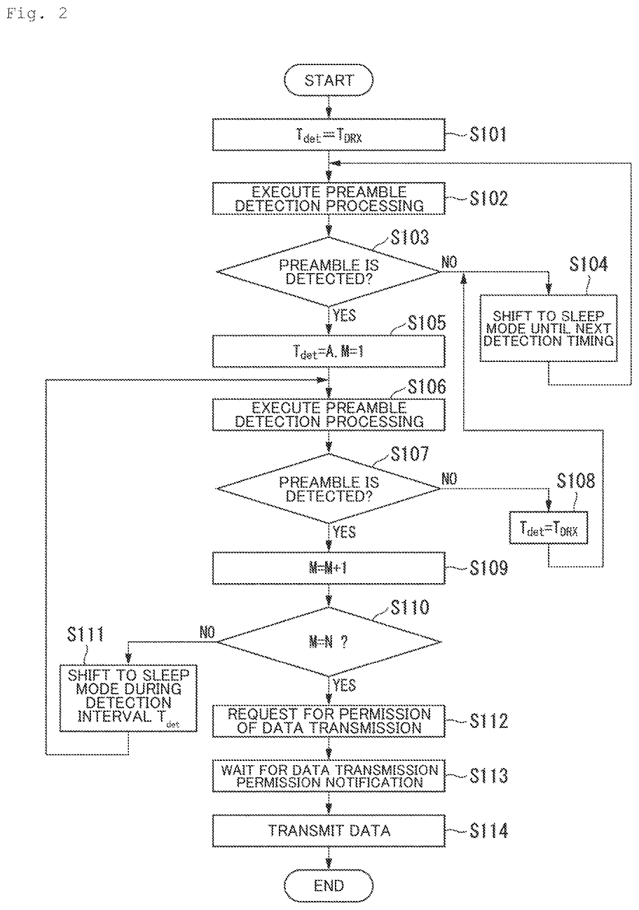

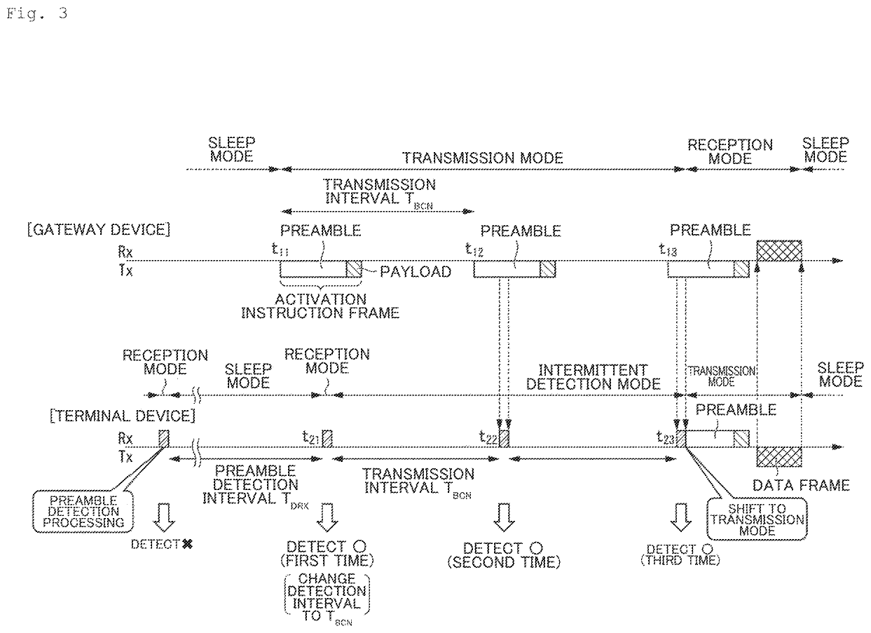

FIG. 2 is a flowchart showing an example of processing in which the terminal device 200 of an embodiment controls the operation mode of the own device. FIG. 3 is a diagram showing an example of an operation by the wireless communication system 100 according to an embodiment. With reference to the example of the operation in FIG. 3 as appropriate, the flow of the processing shown in the flowchart of FIG. 2 will be described below.

First, the control unit 240 sets the detection interval T_{det} to time T_{DRX} which is longer than the interval T_{BCN} at which the gateway device 300 transmits the activation instruction frame (step S101) Here, T_{DRX} is a fixed value determined on the basis of the system design, similarly to the transmission interval T_{BCN}. For example, T_{DRX} and T_{BCN} can be determined by the method described in PTL 1.

Subsequently, the preamble detection unit 234 executes detection processing for detecting a preamble of the activation instruction frame in a predetermined frequency channel (simply referred to as “channel” hereinafter) (step S102). Next, the control unit 240 determines whether or not a preamble of the activation instruction frame is detected in step S102 (step S103). Here, when it is determined that a preamble of the activation instruction frame is not detected (step S103—NO), the control unit 240 shifts the operation mode of the own device to the sleep mode until the detection timing for detecting the next preamble (step S104). More specifically, the control unit 240 causes the own device to shift to the sleep mode for a time period obtained by subtracting the time period required for the detection processing from the detection interval T_{det} (=T_{DRX}) (e.g., time period required for the execution of steps S102 and S103), and then returns the device to the detection mode again to return the processing to the step S102. Thus, step S102 is executed for each detection interval T_{DRX}.

On the other hand, when it is determined that a preamble of the activation instruction frame has been detected (step S103—YES), the control unit 240 changes the detection interval T_{det} to time A which is shorter than the detection interval T_{DRX} in the detection mode, and also initializes M to 1, M being the number of consecutive successful detections of a preamble (referred to as “number of consecutive detections” hereinafter) (step S105). Here, 1 represents the number detected in step S103. For example, in the operation example in FIG. 3, the preamble detection unit 234 changes the detection interval T_{det} to the transmission interval T_{BCN} at which the activation instruction frame is transmitted, in response to detection of the preamble of the activation instruction frame transmitted at time t₁₁.

Subsequently, the control unit 240 waits for the time of the detection interval T_{det} changed in step S105, and then executes detection processing for detecting the preamble of the activation instruction frame (step S106). The control unit 240 determines whether or not the preamble of the activation instruction frame is detected in step S106 (step S107). When it is determined that the preamble of the activation instruction frame is not detected (S107—NO), the control unit 240 returns the detection interval T_{det} to the original T_{D}ax (step S108), and returns the processing to step S102 after sleeping for a time period corresponding to the detection interval T_{det} (=T_{DPX}).

On the other hand, when it is determined that the preamble of the activation instruction frame is detected (step S107—YES), the control unit 240 increments the number of consecutive detections M (step S109), and determines whether the number of consecutive detections M reaches a predetermined number N or not (step S110). Here, when it is determined that the number of consecutive detections M does not reach N (step S110—NO), the control unit 240 returns the processing to step S106 after waiting for the time period corresponding to the detection interval T_{det} (A in this case).

On the other hand, when it is determined that the number of consecutive detections M has reached N (step S110—YES), the control unit 240 transmits a data transmission request to the gateway device 300 (step S112) and waits for receiving a data transmission instruction to be received from the gateway device 300 as a response to the data transmission request (step S113). Once the control unit 240 receives the data transmission instruction from the gateway device 300, the control unit 240 transmits data to the gateway device 300 (step S114), and terminates a series of processing.

For example, in the operation example shown in FIG. 3, the terminal device 200 succeeds in the first preamble detection at time T₂₁ while trying to detect the preamble at the detection interval T_{DRX}. In response to this, the control unit 240 changes the detection interval T_{det} from T_{DRX} to T_{BCN}, and thereafter, the terminal device 200 executes the detection processing for detecting a preamble of the activation instruction frame at the detection interval of T_{BCN}. As a result, the terminal device 200 detects the activation instruction frame transmitted at time t₁₁ at time t₂₁, detects the activation instruction frame transmitted at time t₁₂ at time t₂₂, and detects the activation instruction frame transmitted at time t₁₃ at time t₂₃.

In this case, for example, when the threshold N of the number of consecutive detections is three, the control unit 240 transmits a data transmission request to the gateway device 300 in response to the fact that the preamble is detected at time t₂₃ (i.e., the fact that the detection of the preamble is successful three times consecutively).

In the flowchart of FIG. 2, step S104 is operated in the sleep mode, and steps S101 to S103 are operated in the detection mode. In addition, steps S105 to S111 are operated in the intermittent detection mode, and steps S112 to S114 are operated in the transmission mode. Since the operation in the transmission mode may differ depending on a communication protocol after activation (e.g., a MAC (Media Access Control) protocol), the processing from steps S112 to S114 may be replaced with processing corresponding to the communication protocol after activation. Although FIG. 2 shows the operation in the transmission mode when the communication protocol after the activation is the RIT (Receiver Initiation Transmission) method, when, for example, the communication protocol after the activation is the random access method (ALOHA method), the terminal device 200 may communicate with the gateway device 300 at an arbitrary timing.

That is, when the preamble of the activation instruction frame is not detected in step S103, the control unit 240 shifts the operation mode of the terminal device 200 from the detection mode to the sleep mode, and when the preamble of the activation instruction frame is detected, the control unit 240 shifts the operation mode of the terminal device 200 from the detection mode to the intermittent detection mode. When the number of consecutive detections M reaches the threshold N in step S109, the control unit 240 shifts the operation mode of the terminal device 200 from the intermittent detection mode to the transmission mode. The control unit 240 also shifts the operation mode of the terminal device 200 from the transmission mode to the sleep mode after the transmission of the data in step S113 is ended normally.

The transmission mode of the terminal device 200 may be set to a state in which the activation instruction frame can be transmitted and received. In this manner, the terminal device 200 can acquire the payload of the activation instruction frame detected immediately before shifting to the transmission mode. For example, in the example shown in FIG. 3, the terminal device 200 shifts to the transmission mode in response to the detection of the preamble at time t₂₃ and receives an activation instruction frame having the preamble detected at time t₂₃ after shifting to the transmission mode.

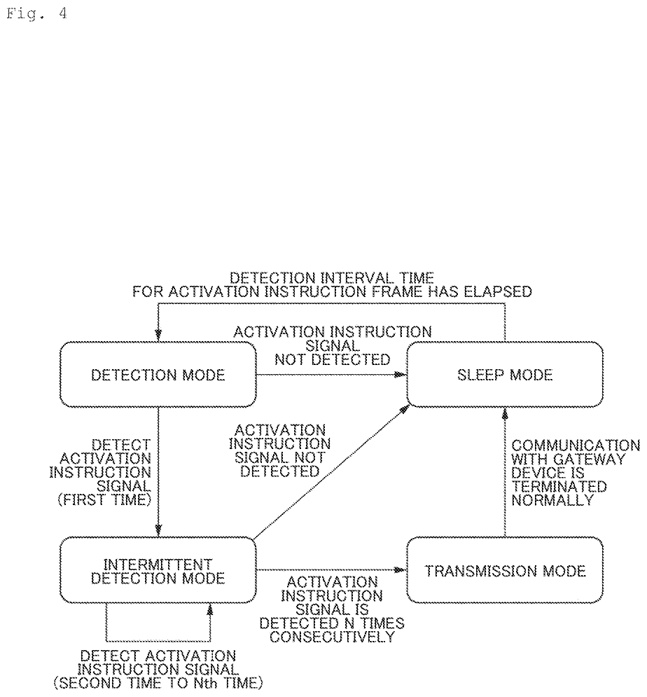

FIG. 4 is a diagram showing a specific example of a transition of the operation mode of the terminal device 200 in an embodiment. As described above, the operation mode of the terminal device 200 transitions between four operation modes, the detection mode, the intermittent detection mode, the transmission mode, and the sleep mode. In the detection mode, the terminal device 200 executes the detection processing for detecting an activation instruction frame at the detection interval T_{DRX}. In the detection mode, when the activation instruction frame is not detected, the terminal device 200 shifts to the sleep mode. On the other hand, when the activation instruction frame is detected in the detection mode, the terminal device 200 shifts to the intermittent detection mode.

In the intermittent detection mode, the terminal device 200 executes the detection processing for detecting the activation instruction frame at a detection interval shorter than the detection interval T_{DRX} in the detection mode. In the intermittent detection mode, when the activation instruction frame is consecutively detected a predetermined number of times, the terminal device 200 shifts to the transmission mode. On the other hand, in the intermittent detection mode, when the detection of the activation instruction frame fails before the number of consecutive detections of the activation instruction frame reaches the predetermined number of times, the terminal device 200 shifts to the sleep mode.

In the transmission mode, first, the terminal device 200 transmits a data transmission request to the gateway device 300, and the gateway device 300 transmits a data transmission instruction in response to the data transmission request. The terminal device 200 transmits data to the gateway device 300 upon reception of the data transmission instruction, and shifts to the sleep mode when communication with the gateway device 300 is terminated normally.

In the wireless communication system 100 of the embodiment configured in this manner, the terminal device 200 can be shifted to the transmission mode when the terminal device 200 consecutively detects the preamble of the activation instruction frame a predetermined number of times. Therefore, according to the wireless communication system 100 of the embodiment, the terminal device 200 operating intermittently can be prevented from erroneously detecting the activation instruction frame.

The foregoing embodiment has described the case where the terminal device 200 changes the interval for detecting a preamble of the activation instruction frame in accordance with the transition of the operation mode between the detection mode and the intermittent detection mode, but the detection interval for detecting the preamble in the detection mode and the detection interval for detecting the preamble in the intermittent detection mode may be defined as separate parameters.

Furthermore, in the foregoing embodiment, the detection mode and the intermittent detection mode are defined as different operation modes. However, although the detection mode and the intermittent detection mode differ from each other in terms of the condition for shifting to the sleep mode or the transmission mode and the intervals for detecting an activation instruction frame, the detection mode and the intermittent detection mode are the same operation state in terms of enabling the detection of an activation instruction frame and share the same resources required for the processing. Therefore, the detection mode and the intermittent detection mode may be integrated into one operation mode.

<Modifications>

The foregoing embodiment has described the configuration in which the terminal device 200 shifts to the transmission mode when an activation instruction frame is detected consecutively a predetermined number of times, and this aims to suppress erroneous activation of the terminal device 200 by determining the shift of the operation mode of the terminal device 200 to the transmission mode by detecting an activation instruction frame a plurality of times instead of once. In this sense, the condition for shifting the terminal device 200 to the transmission mode (referred to as “shift condition” hereinafter) may be based on the fact that the terminal device 200 has detected a plurality of activation instruction frames at previously assumed timing and may not always be based on the fact that a plurality of activation instruction frames are detected consecutively a predetermined number of times. Based on this idea, in attempting to detect an activation instruction frame, which is performed at each detection interval, a pattern of a detection result itself that is obtained until the activation instruction frame is detected a plurality of times (referred to as “detection pattern” hereinafter) can be the shift condition.

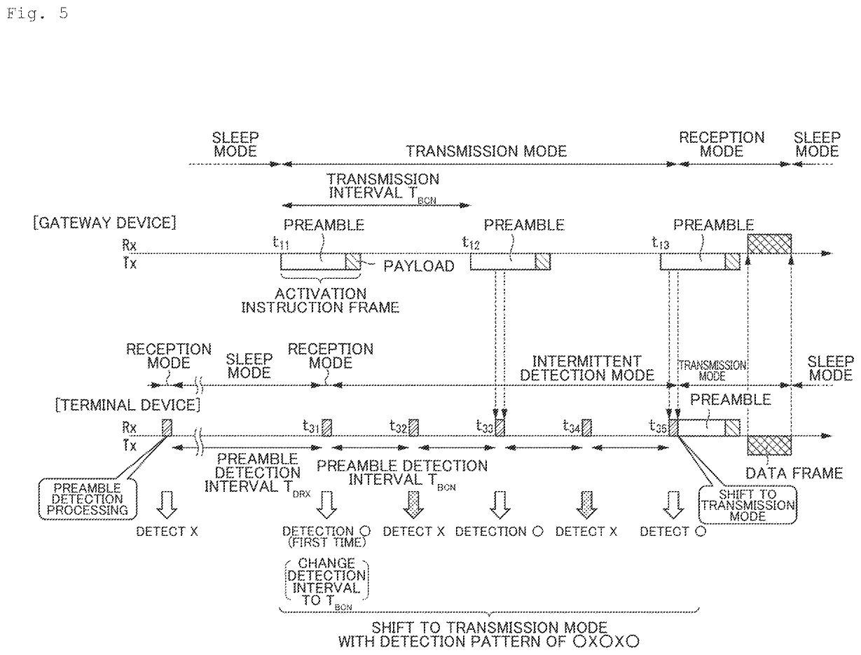

FIG. 5 is a diagram showing an example of an operation by the wireless communication system 100 of a modification. The operation example shown in FIG. 5 differs from the operation example shown in FIG. 3 in that the detection interval in the intermittent detection mode is set to T_{BCN}/2. In this case, it is expected that the pattern of detection of an activation instruction frame by the terminal device 200 is such that detection and non-detection appear alternately. In this case, in the intermittent detection mode, it is possible to set the shift condition in which an activation instruction frame is detected a plurality of times and the detection and non-detection appear alternately.

For example, in the example shown in FIG. 5, an activation instruction frame is detected at times t₃₁, t₃₃, and t₃₅, but an activation instruction frame is not detected at time t₃₂ and t₃₄. This detection pattern is denoted [o (detected), x (not detected), o, x, o] hereinafter. In this case, in the intermittent detection mode, the shift condition can be such that an activation instruction frame is detected in the detection pattern of [o, x, o, x, o]. In this case, for example, when the detection pattern of the shift condition is represented by [o, x, o], the terminal device 200 determines to make a shift to the transmission mode in response to detection of an activation instruction frame at time t₃₃.

When such a detection pattern is used as the shift condition, the variation of detection patterns can be increased by changing the detection interval in the intermittent detection mode on a regular basis. For example, the control unit 240 of the terminal device 200 may be configured to alternately change the detection interval in the intermittent detection mode between T_{BCN} and T_{BCN}/2, and to shift to the transmission mode when an activation instruction frame is detected in a detection pattern assumed by the change of the detection interval. In other words, when the attempt to detect an activation instruction frame is performed three times or more, the length of each detection interval may be set to a plurality of different lengths. The terminal device 200 may include a setting unit for setting a detection pattern with respect to its own device. For example, the setting unit may be configured using an input device such as a keyboard, a mouse, or a touch panel, or may be configured to acquire information indicating a detection pattern from another device by means of a communication function.

The detection mode and the intermittent detection mode in the embodiment described above are examples of the first mode according to the present invention. The transmission mode, which is one of the operation modes of the terminal device 200, is an example of the second mode according to the present invention. The activation instruction frame is an example of an instruction frame according to the present invention.

Although embodiments of the present invention have been described above in detail with reference to the drawings, specific configurations are not limited to these embodiments, and designs and the like within a range not deviating from the gist of the present invention are also included.

### INDUSTRIAL APPLICABILITY

The present invention is applicable to a wireless communication system including a terminal device that performs intermittent operation.

### REFERENCE SIGNS LIST

100 Wireless communication system
200 Terminal device
210 Storage unit
220 Radio antenna
230 Wireless communication unit
231 Transmission unit
232 Modulation/demodulation unit
233 Reception unit
234 Preamble detection unit
240 Control unit
300 Gateway device
310 Storage unit
320 Radio antenna
330 Wireless communication unit
340 Control unit

1. A wireless communication system, comprising:
one or more terminal devices of which an operation mode transitions between (i) a first mode in which a wireless signal can be intermittently detected and (ii) a second mode in which data can be transmitted or received; and
a gateway device, including one or more antennas, configured to transmit, at a predetermined transmission interval, an instruction frame instructing the one or more terminal devices to shift to the second mode,
wherein each of the one or more terminal devices includes an instruction frame detection unit implemented using one or more computing devices, configured to perform detection processing on the instruction frame, and a control unit implemented using one or more computing devices, configured to shift an operation mode of the terminal device from the first mode to the second mode based on a number of times the instruction frame is detected.

2. The wireless communication system according to claim 1, wherein, based on the instruction frame being detected a plurality of times in a plurality of consecutive detection processing steps, the control unit is configured to determine whether or not to shift the terminal device from the first mode to the second mode, based on a combination of detection processing in which the instruction frame is detected and detection processing in which the instruction frame is not detected.

3. The wireless communication system according to claim 2, wherein the terminal device further includes a setting unit implemented using one or more computing devices, configured to, based on the control unit determining to shift the operation mode of the terminal device from the first mode to the second mode, set a pattern of the combination.

4. The wireless communication system according to claim 2, wherein the control unit is configured to determine a length of an interval at which the plurality of consecutive detection processing steps are executed, based on an interval at which the gateway device transmits the instruction frame.

5. The wireless communication system according to claim 1, wherein the control unit is configured to, based on the instruction frame detection unit being performed detection processing three times or more, set a length of an interval, at which the detection processing is executed, to different lengths.

6. A wireless communication method performed by a wireless communication system including (i) one or more terminal devices of which an operation mode transitions between a first mode in which a wireless signal can be intermittently detected and a second mode in which data can be transmitted or received and (ii) a gateway device, including one or more antennas, configured to transmit, at a predetermined transmission interval, an instruction frame instructing the one or more terminal devices to shift to the second mode, including:
performing, by the one or more terminal devices, detection processing on the instruction frame; and
shifting an operation mode of the terminal device from the first mode to the second mode based on a number of times the instruction frame is detected.

7. A terminal device, included in one or more terminal devices in a wireless communication system including (i) the one or more terminal devices of which an operation mode transitions between a first mode in which a wireless signal can be intermittently detected and a second mode in which data can be transmitted or received and (ii) a gateway device, including one or more antennas, configured to transmit, at a predetermined transmission interval, an instruction frame instructing the one or more terminal devices to shift to the second mode, the terminal device comprising:
an instruction frame detection unit, implemented using one or more computing devices, configured to perform detection processing on the instruction frame, and
a control unit, implemented using one or more computing devices, configured to shift an operation mode of the terminal device from the first mode to the second mode based on a number of times the instruction frame is detected.
